(19) United States
(12) Patent Application Publication
(10) Pub. No.: US 2017/0198587 A1
(43) Pub. Date: Jul. 13, 2017

(54) COOLED ARTICLE

(71) Applicants: Srikanth Chandrudu Kottilingam, Simpsonville, SC (US); Benjamin Paul Lacy, Greer, SC (US); David Edward Schick, Greenville, SC (US)

(72) Inventors: Srikanth Chandrudu Kottilingam, Simpsonville, SC (US); Benjamin Paul Lacy, Greer, SC (US); David Edward Schick, Greenville, SC (US)

(21) Appl. No.: 15/066,119

(22) Filed: Mar. 10, 2016

Related U.S. Application Data
(62) Division of application No. 13/777,019, filed on Feb. 26, 2013, now abandoned.

(51) Int. Cl. F01D 5/18; F01D 25/12; F01D 9/02

(52) U.S. Cl. CPC F01D 5/18; F01D 9/02; F01D 25/12; F05D 2220/32; F05D 2230/10; F05D 2230/23; F05D 2300/17

(57) ABSTRACT

The present invention is an article containing internal cooling channels located near at least one surface. In an embodiment, the cooled article includes a base material, a first layer, and a second layer. Here, the first layer is bonded to the base material and the second layer is bonded to the first layer, wherein at least one closed cooling channel is disposed within a portion of the first layer and a portion of the second layer.

### BACKGROUND OF THE INVENTION

The present invention relates generally to an article containing internal cooling channels located near at least one surface; and, more particularly, to a gas turbine component such as a nozzle, bucket or shroud that contains at least one closed cooling channel disposed within a portion of a first layer and a portion of a second layer, wherein the second layer may contain at least one of the component surfaces.

In a gas turbine, pressurized air is mixed with fuel and ignited to generate hot pressurized gases. The hot pressurized gases pass through successive turbine stages that convert the thermal and kinetic energy from the hot pressurized gases to mechanical torque acting on a rotating shaft or other element, thereby producing power used for both compressing the incoming air and driving an external load, such as an electric generator. As used herein, the term “gas turbine” may encompass stationary or mobile turbomachines, and may have any suitable arrangement that causes rotation of one or more shafts.

The components exposed to the hot pressurized gases; particularly, the nozzles, buckets and shrouds; typically contain a plurality of internal channels through which a pressurized fluid, such as compressed air, is caused to flow for the purpose of cooling the component base material. The cooling fluid may be redirected to other portions of the turbine or may exit to the flow of hot pressurized gases through one or more of the component surfaces.

It is often advantageous to form the surfaces and near surface portions of the nozzles, buckets and shrouds from different materials than the base material, in order to insulate the base material from the hot pressurized gases and protect the base material from environmental degradation. These materials may be applied to the base material by a coating method, or may be mechanically attached or metallurgically bonded to the base material.

It is further advantageous to provide additional cooling to the near surface portions of the nozzles, buckets and shrouds to improve the heat transfer qualities of these components; notwithstanding the insulating and protective qualities of the materials used to form the surface and near surface portions. Furthermore, gas turbine nozzles, buckets and shrouds are typically formed by casting methods that use cores to define the internal cooling channels, which limits the extent to which a cooling channel can be located in proximity to a base material surface of the cast component because the cores may move during the casting process.

In view of the above, there is a desire for producing internal channels located within the near surface portions of gas turbine components such as nozzles, buckets and shrouds that may be formed from a plurality of materials.

### BRIEF DESCRIPTION OF THE INVENTION

Embodiments of the present invention are summarized below. These embodiments are not intended to limit the scope of the claimed invention, but rather, these embodiments are intended only to provide a brief summary of possible forms of the invention. Furthermore, the invention may encompass a variety of forms that may be similar to or different from the embodiments set forth below, commensurate with the scope of the claims.

According to a first embodiment of the present invention, a gas turbine system includes at least one compressor, at least one combustor, and at least one turbine; wherein the at least one turbine includes at least one component having a base material; a first layer bonded to the base material and including a first inner surface, a first outer surface, and at least one first channel disposed within a portion of the first layer and being open at the first outer surface; and a second layer bonded to the first layer and including a second inner surface, a second outer surface, and at least one second channel disposed within the second layer, and being open at the second inner surface and fluidically connected with the at least one first channel, thereby forming at least one closed cooling channel disposed within a portion of the first layer and a portion of the second layer.

According to a second embodiment of the present invention, a gas turbine component includes a base material; a first layer bonded to the base material and including a first inner surface, a first outer surface, and at least one first channel disposed within a portion of the first layer and being open at the first outer surface; and a second layer bonded to the first layer and including a second inner surface, a second outer surface, and at least one second channel disposed within the second layer, and being open at the second inner surface and fluidically connected with the at least one first channel, thereby forming at least one closed cooling channel disposed within a portion of the first layer and a portion of the second layer.

According to a third embodiment of the present invention, a gas turbine component includes a base material; a first layer bonded to the base material and including a first inner surface, a first outer surface, and at least one first channel disposed within a portion of the first layer and being open at the first outer surface; and a second layer bonded to the first layer and including a second inner surface, a second outer surface, and at least one second channel disposed within the second layer, and being open at the second inner surface and fluidically connected with the at least one first channel, thereby forming at least one closed cooling channel disposed within a portion of the first layer and a portion of the second layer; which is obtainable by preparing the first layer, applying the second layer to the first outer surface, forming the at least one first channel and the at least one second channel by directionally removing material beginning at the first inner surface and progressing toward the first outer surface and the second inner surface, and bonding the first layer to the base material.

According to a fourth embodiment of the present invention, a method for preparing a gas turbine component includes the steps of preparing a first layer comprising a first inner surface and a first outer surface; applying a second layer comprising a second inner surface and a second outer surface to the first outer surface; forming at least one first channel in the first layer and at least one second channel in the second layer by directionally removing material beginning at the first inner surface and progressing toward the first outer surface and the second inner surface, thereby forming at least one closed cooling channel disposed within a portion of the first layer and a portion of the second layer; and bonding the first layer to a base material.

### BRIEF DESCRIPTION OF THE DRAWINGS

These and other features, aspects and advantages of the present invention may become better understood when the following detailed description is read with reference to the accompanying figures (FIGS), wherein like reference numerals refer to like parts throughout the various views unless otherwise specified.

FIG. 1 is a schematic illustration of an exemplary gas turbine system in which embodiments of the present invention may operate.

FIG. 2 is a partial cross-sectional view of the gas turbine system of FIG. 1 viewed along the line 2-2.

FIG. 3 is an expanded view of the turbine of FIG. 2 taken within the line 3-3.

FIG. 4 is a cross-sectional view of the surface portion of the shroud of FIG. 3 viewed along the line 4-4 and illustrating an embodiment of the present invention.

FIGS. 5 through 8 illustrate steps in the method of forming the surface portion of the shroud of FIG. 4 in accordance with aspects of the present invention.

FIG. 9 is a cross-sectional view of the surface portion of the shroud of FIG. 3 viewed along the line 4-4 and illustrating additional embodiments of the present invention.

### DETAILED DESCRIPTION OF THE INVENTION

Specific embodiments of the present invention are described below. This written description, when read with reference to the accompanying figures, provides sufficient detail to enable a person having ordinary skill in the art to practice the invention, including making and using any devices or systems and performing any incorporated methods. However, in an effort to provide a concise description of these embodiments, every feature of an actual implementation may not be described in the specification, and embodiments of the present invention may be employed in combination or embodied in alternate forms and should not be construed as limited to only the embodiments set forth herein. The scope of the invention is, therefore, indicated and limited only by the claims, and may include other embodiments that may occur to those skilled in the art.

The terminology used herein is for describing particular embodiments only and is not intended to be limiting of example embodiments. As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

Similarly, the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof. As used herein, the term “and/or” includes any, and all, combinations of one or more of the associated listed items.

Certain terminology may be used herein for the convenience of the reader only and is not to be taken as a limitation on the scope of the invention. For example, words such as “upper”, “lower”, “left”, “right”, “front”, “rear”, “top”, “bottom”, “horizontal”, “vertical”, “upstream”, “downstream”, “fore”, “aft”, and the like, when used without further limitation, merely describe the specific configuration illustrated in the various views. Similarly, the terms “first”, “second”, “primary”, “secondary”, and the like, when used without further limitation, are only used to distinguish one element from another and do not limit the elements described.

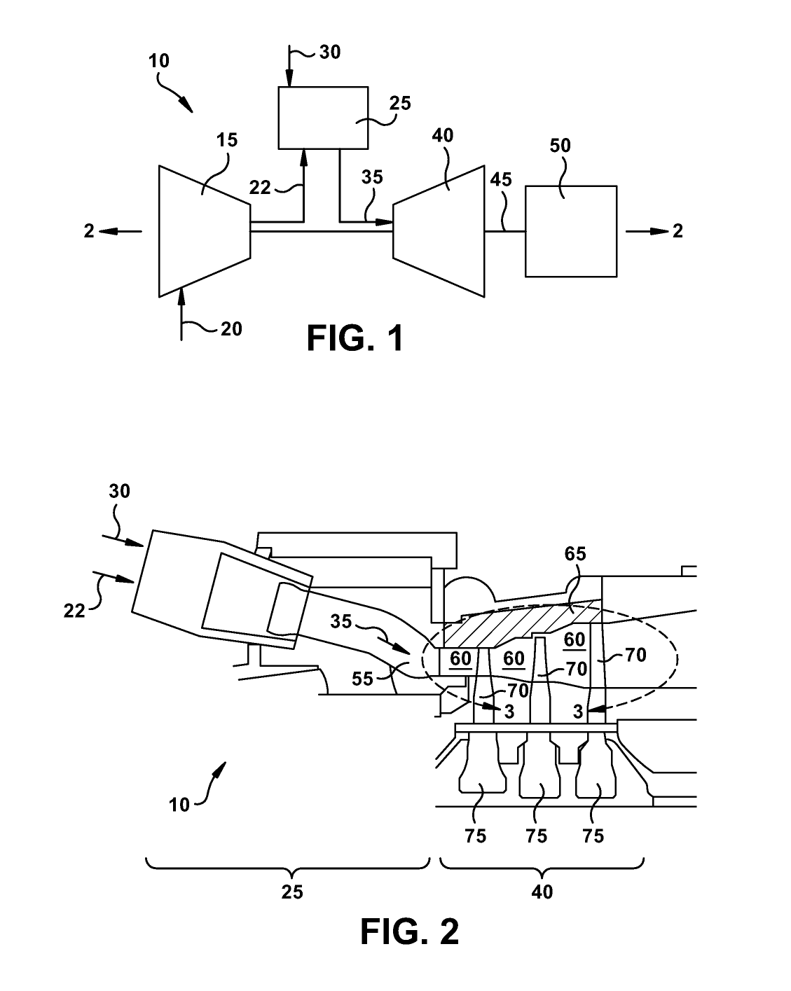

Referring now to the figures (FIGS), wherein like reference numerals refer to like parts throughout the various views unless otherwise specified, FIG. 1 illustrates an exemplary gas turbine system 10 in which embodiments of the present invention may operate. The gas turbine system 10 includes a compressor 15 that compresses an incoming flow of air 20. The compressed flow of air 22 is delivered to at least one combustor 25, in which the air is mixed with fuel 30 and ignited, producing a flow of hot pressurized gases 35. The flow of hot pressurized gases 35 is delivered to a turbine 40, in which the gases pass through one or more stationary and rotating turbine stages that convert the thermal and kinetic energy from the hot pressurized gases to mechanical torque acting on one or more rotating elements connected to a rotating shaft 45. An external load 50, such as a generator, is connected to the shaft 45, thereby converting the mechanical torque to electricity. The shaft 45 may also extend forward through the turbine 40 to drive the compressor 15, or a separate shaft (not illustrated) may be provided from the turbine 40 for that purpose.

FIG. 2 is a partial cross-sectional view of the gas turbine system 10 of FIG. 1 viewed along the line 2-2. The hot pressurized gases 35 exit the combustor 25 through a transition piece 55, which directs the gases 35 into the turbine 40 through a stationary turbine stage 60 that is disposed within an annular casing 65. The hot pressurized gases 35 are directed by the stationary turbine stage 60 into a rotating turbine stage 70, including a rotating disk 75, which is connected to the rotating shaft 45 (FIG. 1). The hot pressurized gases 35 may be further directed to additional stationary and rotating turbine stages (60, 70, 75). Although the turbine 40 is illustrated as including three stages, the components and assemblies described herein may be employed in any suitable type of turbine having any suitable number and arrangement of stages, disks and shafts.

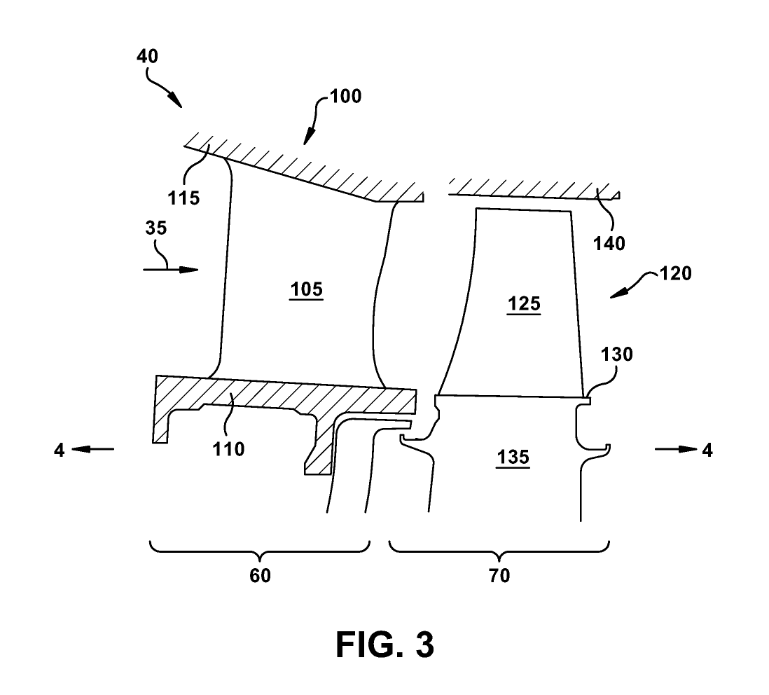

FIG. 3 is an expanded view of the turbine 40 of FIG. 2 taken within the line 3-3, illustrating the first stationary turbine stage 60 and the first rotating turbine stage 70. The hot pressurized gases 35 enter the stationary turbine stage 60 in the direction indicated by the arrow. The stationary turbine stage 60 includes a plurality of circumferentially adjacent nozzles 100 that are radially disposed within the annular casing 65 (FIG. 2). Each nozzle may include an airfoil 105, a radially inner endwall 110 and a radially outer endwall 115 that contain and direct the flow of hot pressurized gases 35 to the rotating turbine stage 70.

The rotating turbine stage 70 includes a plurality of circumferentially adjacent buckets 120 that are connected to and radially disposed about the rotating disk 75 (FIG. 2). Each bucket may include an airfoil 125, a platform 130 and a shank 135. An annular shroud 140 may be disposed at the radially outer end of the airfoil 125 and may be formed from interconnected segments or as a continuous ring. The shroud 140 operates with the airfoil 125 and platform 130 to contain and direct the flow of hot pressurized gases 35 to successive turbine stages.

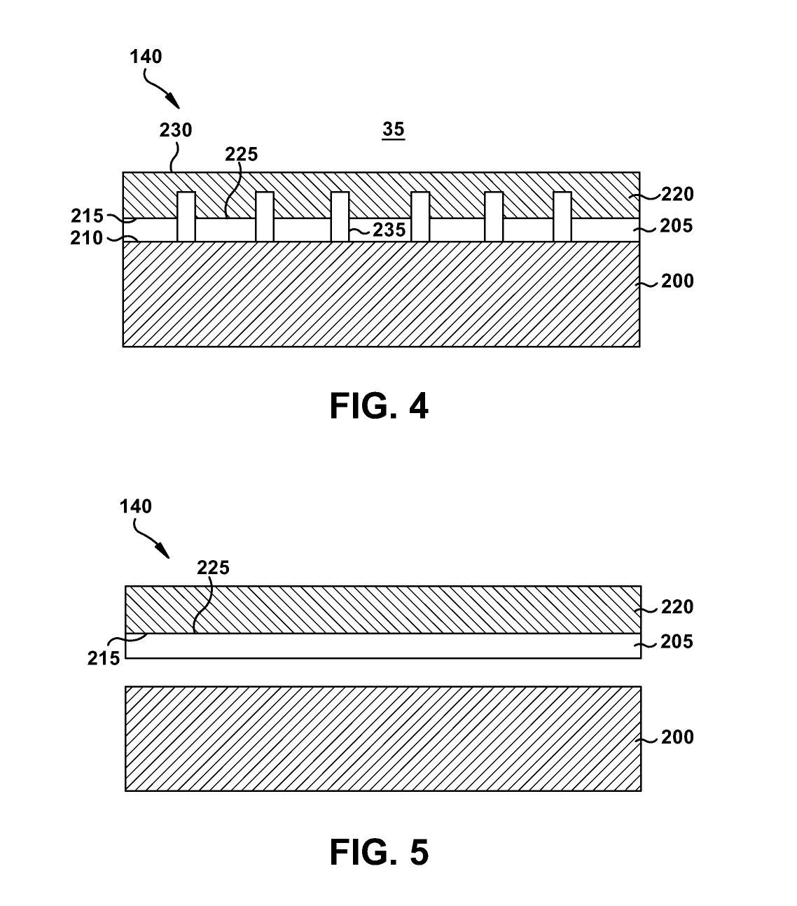

FIG. 4 is a cross-sectional view of the surface portion of the shroud 140 of FIG. 3 viewed along the line 4-4 and illustrating an embodiment of the present invention. As used herein, the line 4-4 represents a direction substantially parallel to the axis of turbine rotation. While the advantages of the present invention will be described with reference to the shroud 140, the teachings of this invention are generally applicable to the nozzles 100, buckets 120 and other hot gas path components of gas turbines developed for industrial and aircraft applications, as well as to other components that are exposed to high temperatures in other types of machines, equipment and systems.

The shroud 140 includes a base material 200, a first layer 205 including a first inner surface 210 and a first outer surface 215, and a second layer 220 including a second inner surface 225 and a second outer surface 230, wherein the second outer surface may form a portion of at least one surface of the shroud that may be in contact with the hot pressurized gases 35 during operation. At least one channel 235 is disposed within a portion of the first layer and a portion of the second layer, which is closed to the second outer surface 230 and has a sufficient cross-sectional area to allow a cooling fluid, such as pressurized air from the compressor 15 (FIG. 1), to flow therethrough. The closed cooling channel 235 may extend any distance into the component in the circumferential direction and at any angle from the axial direction; and may take any suitable form, such as a curve, sinusoid, or serpentine. The closed cooling channel 235 may also be connected with other closed or open channels.

The closed cooling channel 235 may have the form of a rectangular cross-section, as shown in FIG. 4, or may have any other form of cross-section. The width and depth (defined as the dimensions substantially parallel and normal to the first inner surface 210, respectively) of the closed cooling channel 235 may be up to about 0.1 inch (2.5 mm), with a preferred range of about 0.01 inch (0.25 mm) to about 0.05 inch (1.3 mm), and are selected to achieve a cross-sectional area of up to about 0.01 inch² (6.5 mm²), with a preferred range of about 0.0001 inch² (0.065 mm²) to about 0.0025 inch² (1.6 mm²). When more than one closed cooling channel 235 is present, the spacing between the channels may be of any suitable dimension to achieve the desired heat transfer.

The base material 200 may be formed from any suitable material or combination of materials having the strength, ductility and other properties required for the component. Nonlimiting examples include nickel-based superalloys such as Rene N5, GTD-111, and Inconel 738; cobalt- and iron-based superalloys, steel alloys, ceramics, and metallic or ceramic composites; which may be formed by any suitable method such as casting, forging, pressing, or machining.

The first layer 205 may be formed from any suitable material or combination of materials having the mechanical, thermal and environmental characteristics required for the component; and is preferably a pre-sintered preform (PSP) material formed from a mixture of a high melting alloy powder and a low melting alloy powder. Nonlimiting examples of high melting powders include structural alloys and environmental coatings such as Inconel 738, Rene 142, Mar-M247, and GT-33. Nonlimiting examples of low melting powders include braze alloys such as D15, DF4B, BNi-9, BNi-5, and B93. The proportion of low melting powder may range from about 5% to about 95% by weight, and may transition from a higher proportion of low melting powder near the first inner surface 210 to a lower proportion of low melting powder near the first outer surface 215. The thickness of the first layer may range from about 0.005 inch (0.125 mm) to about 0.5 inch (12.7 mm), but is preferably between about 0.01 inch (0.25 mm) to about 0.02 inch (0.5 mm). The first layer 205 may be formed as a flat sheet or contoured into any suitable geometry, including but not limited to the shape of the base material 200, using any suitable method.

The second layer 220 may be formed from any suitable material or combination of materials having the mechanical, thermal and environmental characteristics required for the component. Nonlimiting examples include PtAl, NiCrAlY (e.g. GT-33), and Yttria-Stabilized Zirconia (YSZ); which may be deposited onto the first layer using a thermal spray method such as Air Plasma Spray (APS), Vacuum Plasma Spray (VPS), or High Velocity Oxy-Fuel (HVOF); Physical Vapor Deposition (PVD), or a slurry method. The thickness of the second layer may be up to about 0.1 inch (2.5 mm), and is preferably about 0.01 inch (0.25 mm) to about 0.05 inch (1.3 mm).

FIGS. 5 through 8 illustrate steps in the method of forming a surface portion of the shroud 140 in accordance with aspects of the present invention. The method disclosed herein may be performed as many times as desired, either sequentially or simultaneously, such that any surface portion or the entire surface of the shroud is thereby formed.

As shown in FIG. 5, the base material 200 is formed separately from the first layer 205 and the second layer 220. The first layer 205 and the second layer 220 may be formed concurrently or in successive steps that produce a mechanical, chemical or metallurgical bond between the first outer surface 215 and the second inner surface 225.

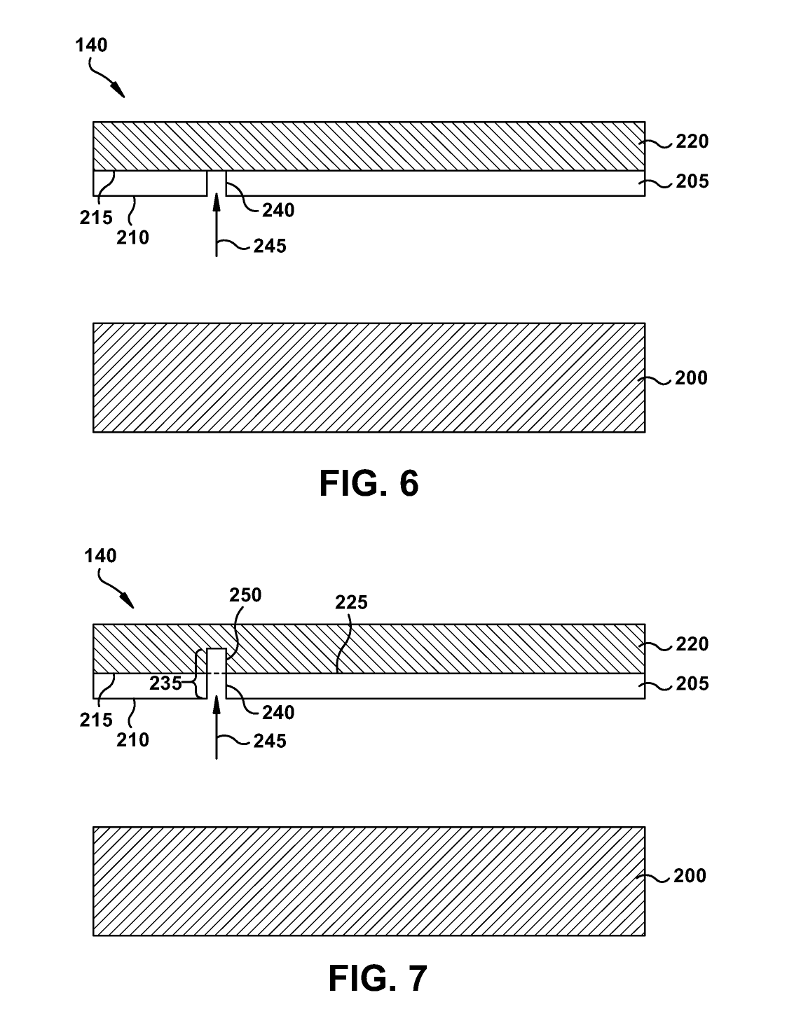

As shown in FIG. 6, after the first layer 205 and the second layer 220 are formed and bonded together, at least one first channel 240 is formed in the first layer 205 by directionally removing material, beginning at the first inner surface 210 and progressing toward the first outer surface 215 in the direction indicated by the arrow 245. The first channel 240 may be formed by any suitable method; including but not limited to milling, grinding, electrical discharge machining (EDM), electro-chemical machining (ECM), waterjet trenching, and laser trenching.

As shown in FIG. 7, the first channel 240 is extended in the direction indicated by the arrow 245 such that a second channel 250 is formed in the second layer 220 and is fluidically connected with the first channel 240. The second channel 250 may be formed by any suitable method, which may be the same method used to form the first channel 240 or a different method. The width of the second channel 250 may be substantially the same as the width of the first channel 240 or may be wider or narrower than the width of the first channel 240, as long as the average dimensions and total cross-sectional area of the resulting channel (corresponding to the closed cooling channel 235 of FIG. 4) are substantially within the ranges given above. The methods used to form the first channel 240 and the second channel 250 may be used sequentially or simultaneously to form any number of additional first and second channels.

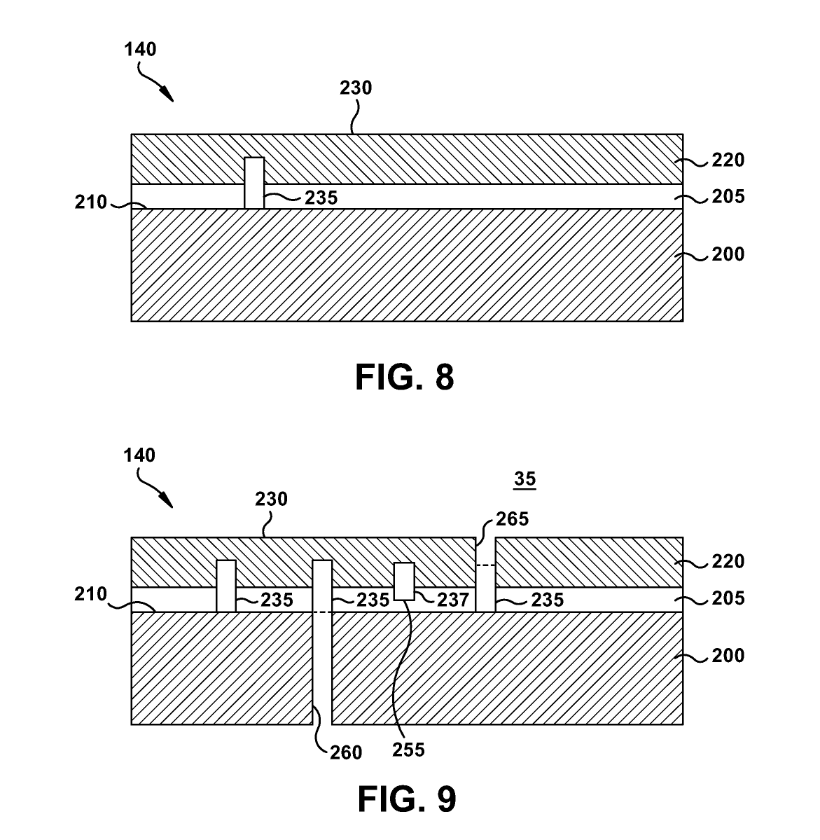

As shown in FIG. 8, after the desired number of first channels 240 and second channels 250 are formed, the first layer 205 is bonded to the base material 200 at the first inner surface 210 using any suitable method, thereby producing at least one closed cooling channel 235. When the first layer 205 is a pre-sintered preform (PSP), the first layer may be bonded to the base material by simultaneously heating the first layer and the base material to a temperature greater than the melting point of the low melting powder and less than the melting point of the high melting powder in the first layer, such that the low melting powder becomes the bonding agent between the first layer and the base material.

FIG. 9 is a cross-sectional view of the surface portion of the shroud 140 of FIG. 3 viewed along the line 4-4 and illustrating additional embodiments of the present invention. In an embodiment, the first layer 205 may collapse in the region 255 during the step of bonding the first layer 205 to the base material 200, resulting in a truncated closed cooling channel 237 that does not extend to the first inner surface 210. In another embodiment, one or more of the closed cooling channels 235 may be fluidically connected with at least one third channel 260 formed in the base material that supplies the cooling fluid from an internal portion of the component. In yet another embodiment, one or more of the closed cooling channels 235 may be fluidically connected with at least one fourth channel 265 being open at the second outer surface that allows the cooling fluid to exit to the hot pressurized gases 35. The third channel 260 and fourth channel 265 may be formed using any suitable method, either prior to or following the step of bonding the first layer 205 to the base material 200.

As described above, the present invention contemplates a gas turbine component such as a nozzle, bucket or shroud containing at least one closed cooling channel disposed within a portion of a first layer and a portion of a second layer, wherein the second layer may contain at least one of the component surfaces. The present invention also contemplates a method of forming a portion of at least one surface of a gas turbine component, wherein at least one closed cooling channel is located near the component surface.

Although specific embodiments are illustrated and described herein, including the best mode, those of ordinary skill in the art will appreciate that all additions, deletions and modifications to the embodiments as disclosed herein and which fall within the meaning and scope of the claims may be substituted for the specific embodiments shown. Similarly, other embodiments of the invention may be devised which do not depart from the spirit or scope of the present invention. Such other embodiments are intended to be within the scope of the claims if they have structural elements that do not differ from the literal language of the claims, or if they include equivalent structural elements with insubstantial differences from the literal languages of the claims. Likewise, the system components illustrated are not limited to the specific embodiments described herein, but rather, system components can be utilized independently and separately from other components described herein. For example, the components and assemblies described herein may be employed in any suitable type of gas turbine, aircraft engine, or other turbomachine having any suitable number and arrangement of stages, disks and shafts while still falling within the meaning and scope of the claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A method for preparing a gas turbine component comprising the steps of:
preparing a first layer comprising a first inner surface and a first outer surface;
applying a second layer comprising a second inner surface and a second outer surface to the first outer surface;
forming at least one first channel in the first layer and at least one second channel in the second layer by directionally removing material, beginning at the first inner surface and progressing toward the first outer surface and the second inner surface, thereby forming at least one closed cooling channel disposed within a portion of the first layer and a portion of the second layer; and
bonding the first layer to a base material.

18. The method of claim 17, wherein the first layer comprises a high melting alloy and a low melting alloy.

19. The method of claim 17, wherein the step of bonding the first layer to the base material comprises heating the first layer and the base material to a temperature greater than the melting point of the low melting alloy.

20. The method of claim 17, comprising the additional steps of removing excess material from the base material, the first layer, and the second layer as required to achieve the final dimensions of the component.
